(19) United States
(12) Patent Application Publication
(10) Pub. No.: US 2026/0091876 A1
(43) Pub. Date: Apr. 2, 2026

(54) AIRCRAFT PROPULSION ASSEMBLY COMPRISING A LOAD-BEARING STRUCTURE INTERPOSED BETWEEN AN ENGINE UNIT AND A PRIMARY STRUCTURE OF A PYLON

(71) Applicant: Airbus Operations SAS, TOULOUSE (FR)

(72) Inventors: Olivier PAUTIS, TOULOUSE (FR); Nicolas CHARTON, TOULOUSE (FR); Julien VINOT, TOULOUSE (FR)

(21) Appl. No.: 19/341,256

(22) Filed: Sep. 26, 2025

(30) Foreign Application Priority Data
Sep. 30, 2024 (FR) FR2410500

(51) Int. Cl. B64D 27/40; B64D 29/06

(52) U.S. Cl. CPC B64D 27/402; B64D 27/406; B64D 29/06

(57) ABSTRACT

An aircraft propulsion assembly including an engine unit, a primary structure of the pylon, a nacelle surrounding a rear part of the engine unit, an engine mount system which includes a load-bearing structure positioned between the engine unit and the nacelle, a first connecting system of the rigid type, connecting the front end of the load-bearing structure and the front part of the engine unit, a second connecting system of the rigid type connecting the load-bearing structure and the primary structure, at least one rear damping engine mount interposed between the rear part of the engine unit and the nacelle.

### CROSS-REFERENCES TO RELATED APPLICATIONS

This application claims the benefit of French Patent Application Number FR2410500 filed on Sep. 30, 2024, the entire disclosures of which are incorporated herein by way of reference.

### FIELD OF THE INVENTION

The present application relates to an aircraft propulsion assembly comprising a load-bearing structure interposed between an engine unit and a primary structure of a pylon and an aircraft comprising at least one such propulsion assembly.

### BACKGROUND OF THE INVENTION

According to a configuration which can be seen in FIGS. 1 to 3, an aircraft 10 comprises a plurality of propulsion assemblies 12 which are positioned below the wing 14 of the aircraft 10.

A propulsion assembly 12 comprises an engine unit 16, a nacelle (not shown in FIGS. 2 and 3) positioned around the engine unit 16 and a pylon 18 connecting the engine unit 16 to the remainder of the aircraft 10, in particular to the wing 14.

For the remainder of the description, a longitudinal direction X is parallel to the axis of rotation A16 of the engine unit 16. A transverse plane is a plane perpendicular to the axis of rotation A16 of the engine unit 16. A longitudinal plane is a plane passing through the axis of rotation A16 of the engine unit 16. A transverse and horizontal direction Y is a direction perpendicular to the axis of rotation A16 of the engine unit 16 and horizontal. A transverse and vertical direction Z is a direction perpendicular to the axis of rotation A16 of the engine unit 16 and vertical. A vertical median plane PMV is a vertical plane containing the axis of rotation A16 of the engine unit 16. The terms “front” and “rear” refer to the direction of flow of the airflow in the engine unit 16, this airflow flowing from the front to the rear.

The engine unit 16 comprises a fan 20 which has a fan housing 20.1 and a reactor core 22 which has a front part 22.1 positioned inside the fan 20, a central part 22.2 and a rear part 22.3 integrating, in particular, a nozzle. According to one configuration, the central part 22.2 has a cross section which is smaller than that of the front and rear parts 22.1, 22.3. The reactor core 22 has an external shell called the engine casing F22.

The pylon 18 comprises a primary structure 24 in the form of a box which is connected to the wing 14 by a wing mount system 26 and to the engine unit 16 by an engine mount system 28. This primary structure 24 comprises a front end 24.1, a central part 24.2 and a rear end 24.3.

According to a first embodiment which can be seen in FIG. 2, the engine mount system 28 comprises a front mount 28.1 connecting the front end 24.1 of the primary structure 24 and the front part and/or central part 22.1, 22.2 of the reactor core 22, a rear mount 28.2 connecting the rear end 24.3 of the primary structure 24 and the rear part 22.3 of the reactor core 22 and two connecting rods 28.3 positioned symmetrically relative to the vertical median plane PMV of the engine unit 16, connecting the primary structure 24 and the front part and/or central part 22.1, 22.2 of the reactor core 22.

According to a second embodiment which can be seen in FIG. 3, the engine mount system 28 comprises a front mount 28.1 connecting the front end 24.1 of the primary structure 24 and the fan housing 20.1 of the fan 20, a rear mount 28.2 connecting the rear end 24.3 of the primary structure 24 and the rear part 22.3 of the reactor core 22 and two connecting rods 28.3 positioned symmetrically relative to the vertical median plane PMV of the engine unit 16, connecting the primary structure 24 and the front part and/or central part 22.1, 22.2 of the reactor core 22.

In some circumstances, these two embodiments do not permit an optimal transfer of forces between the engine unit and the primary structure 24 of the pylon 18.

### SUMMARY OF THE INVENTION

The present invention aims to remedy all or some of the drawbacks of the prior art.

To this end, a subject of the invention is an aircraft propulsion assembly comprising:
an engine unit which comprises front and rear parts, the rear part being connected to the front part,
a primary structure of the pylon,
a nacelle configured to surround at least the rear part of the engine unit, and
an engine mount system connecting the primary structure and the engine unit.

According to the invention the engine mount system comprises:
a load-bearing structure which extends between a front end and a rear end, surrounding the rear part of the engine unit and positioned between the engine unit and the nacelle,
a first connecting system of the rigid type, positioned in a first transverse plane, connecting the front end of the load-bearing structure and the front part of the engine unit,
a second connecting system of the rigid type, connecting the load-bearing structure and the primary structure, and
at least one rear damping engine mount interposed between the rear part of the engine unit and at least one element from the nacelle and the load-bearing structure, the rear damping engine mount being positioned in a second transverse plane offset to the rear relative to the first transverse plane.

This solution makes it possible to optimize the transmission of forces between the engine unit and the primary structure of the pylon.

According to a further feature, the load-bearing structure is a trellis structure.

According to a further feature, the load-bearing structure comprises at least two transverse reinforcements positioned in transverse planes and joint reinforcements connecting the transverse reinforcements so as to form the trellis structure, each transverse reinforcement describing a circular arc positioned in a transverse plane which extends between the first and second ends, each connected to the primary structure; the second connecting system comprising, for each end, a rigid connection connecting the end and the primary structure.

According to a further feature, the load-bearing structure comprises a plurality of sections configured to occupy an assembled state and a disassembled state, the sections of the load-bearing structure being dimensioned so as to permit an insertion of the engine unit inside the load-bearing structure in the disassembled state.

According to a further feature, at least one of the transverse reinforcements comprises a first section connected to the primary structure, a second section connected to the primary structure and a lower section connected to the first and second sections by at least one dismountable connection and/or by at least one hinge.

According to a further feature, the first connecting system comprises two front mounts positioned at each of the ends of the first section of a first transverse reinforcement located furthest to the front and two front mounts positioned at each of the ends of the second section of the first transverse reinforcement. According to a further feature, the propulsion assembly comprises at least one item of ancillary equipment supported by the load-bearing structure and connected thereto.

According to a further feature, the rear damping engine mount comprises a plurality of first studs attached to an external surface of the rear part of the engine unit and positioned in a second transverse plane.

According to a further feature, the rear damping engine mount comprises a plurality of second studs attached to an internal surface of the nacelle and positioned in the second transverse plane.

According to a further feature, the first and second studs are arranged so as to be placed against one another.

According to a further feature, at least some second studs are connected to one another by a ring or at least one ring segment positioned in the second transverse plane.

According to a further feature, the nacelle comprises first and second cowlings, each configured to occupy a closed state in which the cowling is in the vicinity of the load-bearing structure and an open state in which the cowling is spaced apart from the load-bearing structure, the second studs being attached to an internal surface of the first and second cowlings.

According to a further feature, the studs are made of a resiliently deformable material.

A further subject of the invention is an aircraft comprising at least one propulsion assembly according to one of the preceding features.

### BRIEF DESCRIPTION OF THE DRAWINGS

Further features and advantages will be found in the following description of the invention, the description made solely by way of example with reference to the accompanying drawings, in which:

FIG. 1 is a perspective view of an aircraft,

FIG. 2 is a lateral schematic view of an aircraft propulsion assembly (without nacelle) illustrating a first embodiment of the prior art,

FIG. 3 is a lateral schematic view of an aircraft propulsion assembly (without nacelle) illustrating a second embodiment of the prior art,

FIG. 4 is a lateral schematic view of an aircraft propulsion assembly illustrating an embodiment of the invention,

FIG. 5 is a lateral schematic view of an aircraft propulsion assembly illustrating a further embodiment of the invention,

FIG. 6 is a lateral schematic view of the aircraft propulsion assembly which can be seen in FIG. 5 showing the distribution of inertial loads applied to the engine unit and the force paths,

FIG. 7 is a perspective view of an aircraft propulsion assembly with open cowlings illustrating an embodiment of the invention,

FIG. 8 is a perspective view of an aircraft propulsion assembly with closed cowlings illustrating an embodiment of the invention,

FIG. 9 is a section along the line IX-IX of a part of the aircraft propulsion assembly which can be seen in FIG. 8,

FIG. 10 is a section of a part of the aircraft propulsion assembly illustrating a detail of FIG. 9,

FIG. 11 is a perspective view of a load-bearing structure illustrating an embodiment of the invention,

FIG. 12 is a perspective view of a load-bearing structure illustrating a further embodiment,

FIGS. 13A and 13B are schematic views of the load-bearing structure which can be seen in FIG. 12 in the dismounted state on the part (13A) and in the partially assembled state on the part (13B),

FIG. 14 is a rear view of a propulsion assembly comprising a load-bearing structure supporting ancillary equipment (with open cowlings) illustrating an embodiment of the invention,

FIG. 15 is a rear view of the propulsion assembly which can be seen in FIG. 14.

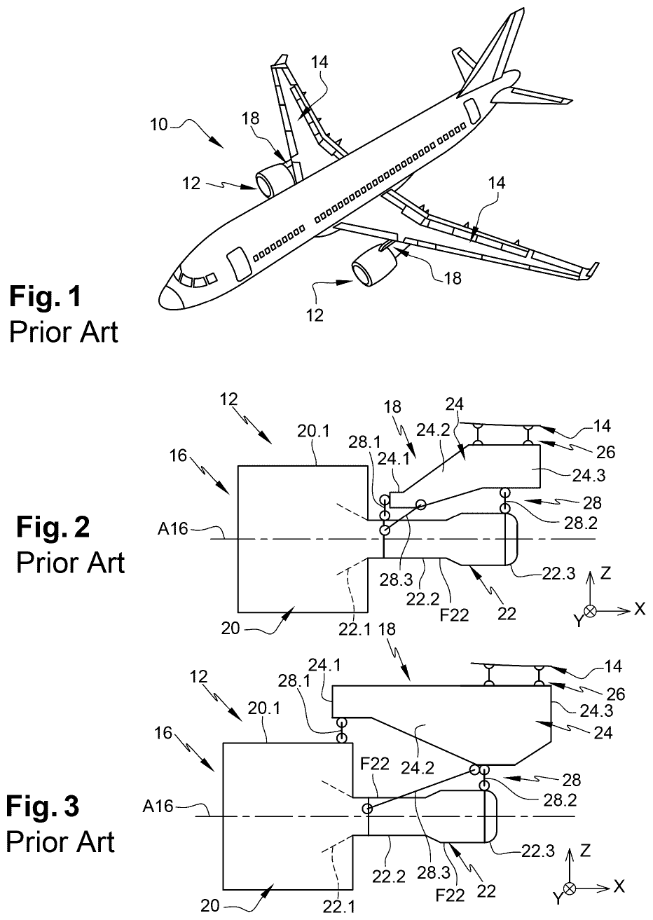

### DETAILED DESCRIPTION OF THE PREFERRED EMBODIMENTS

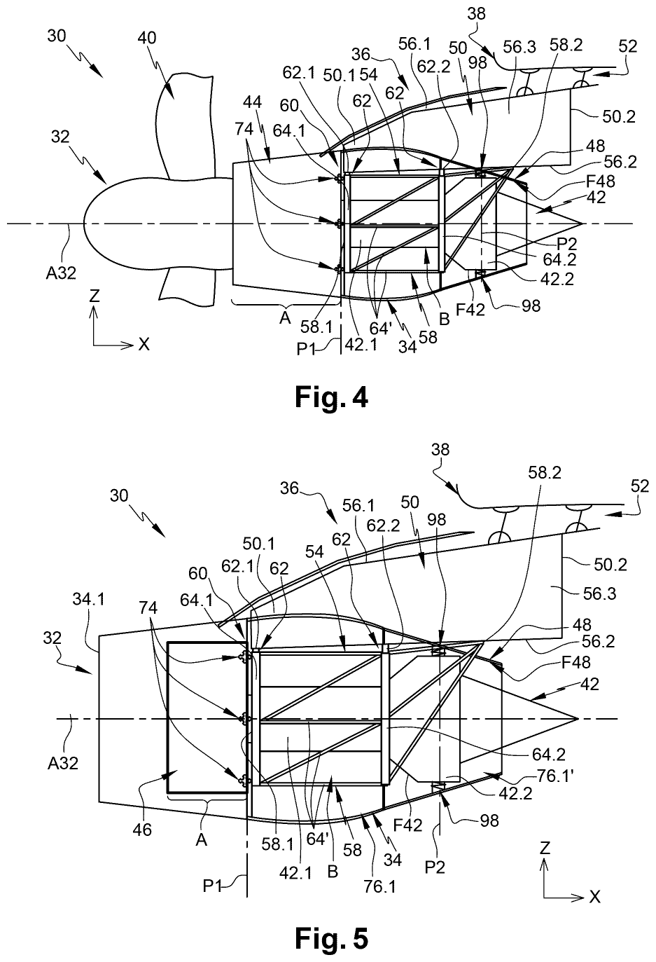

According to an embodiment which can be seen in FIGS. 4 to 15, a propulsion assembly 30 comprises an engine unit 32 having an axis of rotation A32, a nacelle 34 (which can be seen, in particular, in FIGS. 4 to 6) positioned around the engine unit 32 and a pylon 36 configured to connect the propulsion assembly 30 and more particularly the engine unit 32 to an aircraft structure 38 such as a wing, for example. An aircraft 10 comprises at least one such propulsion assembly 30.

According to a configuration which can be seen in FIG. 4, the engine unit 32 is a turboprop engine. According to this configuration, the propulsion assembly 30 comprises, at the front of the engine unit 32, a propeller 40 coupled to the engine unit 32. This engine unit comprises a reactor core 42 and a front casing 44 containing a gearbox which couples the reactor core 42 and the propeller 40. In this case, the nacelle 34 surrounds the reactor core 42. The nacelle is approximately tubular and located to the rear of the front casing 44 in the extension thereof.

According to a further configuration which can be seen in FIG. 5, the engine unit 32 is a turbojet which comprises a fan 46 and a reactor core 42. In this case, the nacelle 34 surrounds the fan 46 and the reactor core 42. The nacelle is approximately tubular and has an air inlet 34.1 at the front of the fan 46.

Whatever the configuration, the engine unit 32 is configured to generate thrust forces and comprises a front part A as the front casing 44 in the case of a turboprop engine or the fan 46 in the case of a turbojet, for example, and a rear part B as the reactor core 42, for example connected to the front part A and positioned to the rear of the front part A which has a section (dimension taken in a transverse plane) which is smaller than the front part A. The thrust forces are transmitted to the aircraft structure 38 via the front part A.

The rear part B of the engine unit 32 integrates, in particular, rotating stages of compressors and high-pressure and low-pressure turbines and a nozzle. According to one configuration, the reactor core 42 has an external surface F42 called the engine casing.

The nacelle 34 is configured to surround at least the rear part B of the engine unit 32 and comprises at least one tubular wall 48 which has an internal surface F48 oriented toward the rear part 42.2 of the reactor core 42.

The pylon 36 comprises a primary structure 50 in the form of a box which is connected to the aircraft structure 38 by a wing mount system 52 and to the engine unit 32 by an engine mount system 54. This primary structure 50 extends from a front end 50.1 to a rear end 50.2. According to an embodiment which can be seen in FIG. 7, the primary structure 50 comprises an upper longitudinal member 56.1, a lower longitudinal member 56.2 and first and second lateral walls 56.3, 56.4.

The engine mount system 54 comprises a load-bearing structure 58 which extends between a front end 58.1 and a rear end 58.2, a first connecting system 60 connecting the front end 58.1 of the load-bearing structure 58 and the front part A to the engine unit 32 and a second connecting system 62 connecting the load-bearing structure 58 and the primary structure 50 of the pylon 36.

According to one embodiment, the load-bearing structure 58 is approximately tubular and positioned around the rear part B of the engine unit 32 between the nacelle 34 and this rear part B.

According to one configuration, the load-bearing structure 58 is a perforated structure, separate from the primary structure 50 of the pylon and the external shell F42 of the reactor core 42. It has a perforation rate of at least 50% (corresponding to the ratio of the sum of the open surfaces to the total surface). Moreover, in contrast to the external shell F42 of the reactor core 42, it has a sufficient rigidity to form a force path between the engine unit 32 and the primary structure 50. According to one embodiment, this perforated structure 58 is a trellis structure. This load-bearing structure 58 comprises at least two transverse reinforcements 64.1, 64.2 positioned in transverse planes and joint reinforcements 64′ connecting the transverse reinforcements 64.1, 64.2 so as to form the trellis structure. According to one arrangement, some joint reinforcements 64′ are parallel to the longitudinal direction X while others are oblique and form an angle with the longitudinal direction X.

According to a first embodiment which can be seen in FIGS. 4 and 5, the load-bearing structure 58 comprises first and second transverse reinforcements 64.1, 64.2 in the form of frames surrounding the rear part B of the engine unit 32, the first transverse reinforcement 64.1 located furthest to the front being connected to the front part A of the engine unit 32 by the first connecting system 60. The second connecting system 62 comprises a first mount 62.1 connecting the first transverse reinforcement 64.1 and the primary structure 50 and a second mount 62.2 connecting the second transverse reinforcement 64.2 and the primary structure 50.

According to a second embodiment which can be seen in FIGS. 7, 8, 13A, 13B and 14, the load-bearing structure 58 comprises four transverse reinforcements 64.1, 64.2, 64.3, 64.4, each describing a circle or a circular arc positioned in a transverse plane. According to one arrangement, each of the first, second and third transverse reinforcements 64.1, 64.2, 64.3 located furthest to the front describes a circular arc which extends between first and second ends 66.1, 66.2, each connected to the primary structure 50, respectively to the first and second lateral walls 56.3, 56.4 of the primary structure 50. The fourth reinforcement 64.4 located furthest to the rear describes a circular arc positioned against the lower longitudinal member 56.2 of the primary structure 50.

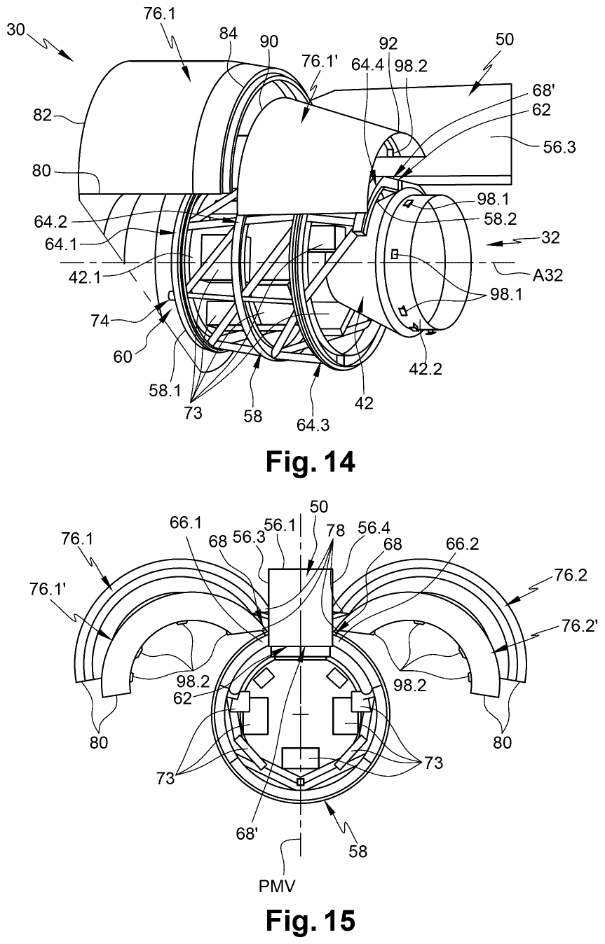

According to the second embodiment, the second connecting system 62 comprises, for each end 66.1, 66.2 of each of the first, second and third transverse reinforcements 64.1, 64.2, 64.3, a rigid connection 68 connecting the end 66.1, 66.2 and the primary structure 50. In addition, the connecting system 62 comprises a rigid connection 68′ (which can be seen in FIG. 14) connecting the fourth transverse reinforcement 64.4 and the primary structure 50. According to one configuration, each rigid connection 68, 68′ is an assembly which makes it possible to connect two elements (a transverse reinforcement and the primary structure) by connecting elements such as bolts, for example. Naturally, the invention is not limited to this solution for the rigid connections 68, 68′.

According to one arrangement, the load-bearing structure 58 is approximately symmetrical relative to the vertical median plane PMV which can be seen in FIG. 15.

According to one embodiment which can be seen in FIG. 11, the load-bearing structure 58 is produced in a single part.

According to one embodiment in FIGS. 12 and 13A and 13B, the load-bearing structure 58 is produced in a plurality of sections configured to occupy an assembled state which can be seen in FIG. 12 and a disassembled state which can be seen in FIGS. 13A and 13B, the sections of the load-bearing structure 58 being dimensioned so as to permit the insertion of the engine unit 32 inside the load-bearing structure 58 in the disassembled state. As illustrated in FIGS. 13A and 13B, according to one configuration, at least one of the transverse reinforcements 64.1, 64.2, 64.3 comprises a first section 70.1 connected to the first lateral wall 56.3 of the primary structure 50, a second section 70.2 connected to the second lateral wall 56.4 of the primary structure 50 and a lower section 70.3 connected to the first and second sections 70.1, 70.2 by at least one dismountable connection and/or by at least one hinge. According to an arrangement which can be seen in FIG. 13A, the lower section 70.3 is connected to the first section 70.1 by a first dismountable connection 72 and to the second section 70.2 by a second dismountable connection 72′. According to a further arrangement which can be seen in FIG. 13B, the lower section 70.3 is connected to the first section 70.1 by a hinge 72.1 and to the second section 70.2 by a dismountable connection 72.2.

The propulsion assembly 30 comprises at least one item of ancillary equipment 73, for example a heat exchanger. According to one configuration which can be seen in FIGS. 14 and 15, at least one of the items of ancillary equipment 73 of the propulsion assembly 30 is supported by the load-bearing structure 58 and connected thereto. According to one arrangement, at least one item of ancillary equipment 73 connected to the load-bearing structure 58 is positioned in a zone located between the load-bearing structure 58 and the engine unit 32 as illustrated in FIG. 15. As a variant or in addition, at least one item of ancillary equipment 73 connected to the load-bearing structure 58 is positioned in a zone located between the load-bearing structure 58 and the nacelle 34.

According to a further embodiment, the first connecting system 60 is positioned in a first transverse plane P1 and comprises a plurality of front mounts 74 connecting the load-bearing structure 58 and the front part A of the engine unit 32. The first connecting system 60 comprises at least three front mounts 74. According to one embodiment, the first connecting system 60 comprises four front mounts 74, positioned symmetrically relative to the vertical median plane PMV located in the region of the first transverse reinforcement 64.1. According to one arrangement, two front mounts 74 are positioned at each of the ends of the first section 70.1 of the first transverse reinforcement 64.1 and two front mounts 74 are positioned at each of the ends of the second section 70.2.

Each of the front mounts 74 is a rigid connection which corresponds to an assembly which makes it possible to connect two elements (the transverse reinforcement 64.1 and the front part A of the engine unit 32) by connecting elements, such as bolts, for example. Naturally, the invention is not limited to this solution for the front mounts 74.

Whatever the embodiment, the front mounts 74 are positioned approximately in the first transverse plane P1. Whatever the number of front mounts 74, the first connecting system 60 is configured to achieve an isostatic or hyperstatic connection between the front part A of the engine unit 32 and the load-bearing structure 58 and to provide an absorption of forces in the longitudinal direction X such as thrust forces, and the transverse and horizontal direction Y such as inertial loads of the front part A of the engine unit 32.

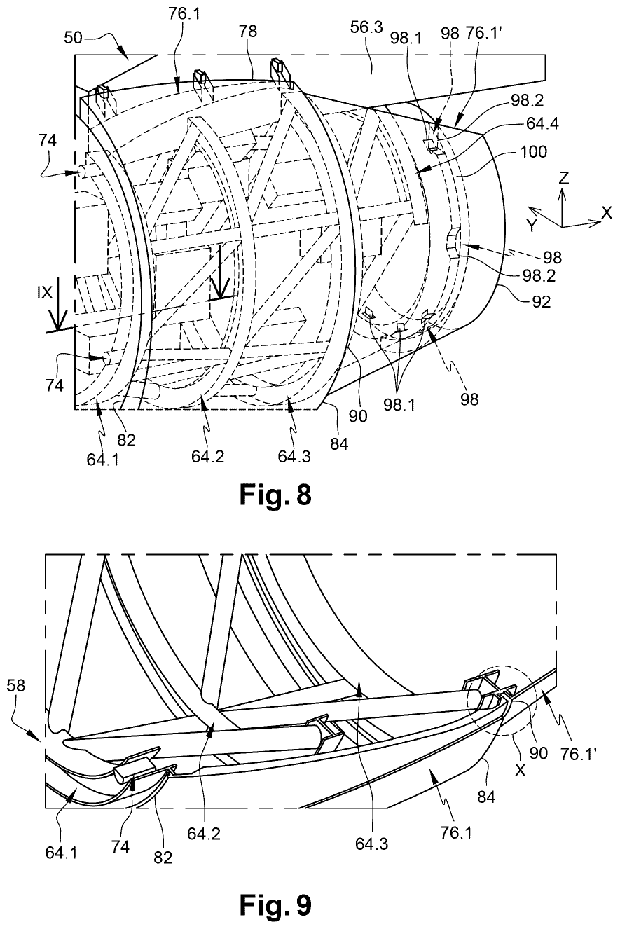

According to one embodiment, the nacelle 34 comprises at least one cowling configured to occupy a closed state, which can be seen in FIG. 8, in which the cowling is in the vicinity of the load-bearing structure 58 and the nacelle 34 and forms a shell which surrounds the engine unit 32 and an open state which can be seen in FIGS. 14 and 15 in which the cowling is spaced apart from the load-bearing structure 58 and permits access to the engine unit 32. According to one configuration, the nacelle 34 comprises a first front cowling 76.1, a first rear cowling 76.1′, a second front cowling 76.2, and a second rear cowling 76.2′, the first and second front cowlings 76.1, 76.2 being symmetrical relative to the vertical median plane PMV, and the first and second rear cowlings 76.1′, 76.2′ being symmetrical relative to the vertical median plane PMV.

Each of the first and second front or rear cowlings 76.1, 76.1′, 76.2, 76.2′ extends between a first edge 78 connected by a hinge to the primary structure 50 and a second free edge 80 opposing the first edge 78. In the open state, the second edges 80 of the first and second front or rear cowlings 76.1, 76.1′, 76.2, 76.2′ are spaced apart. In the closed state, the second edges 80 of the first and second front or rear cowlings 76.1, 76.1′, 76.2, 76.2′ are contiguous and are held in a contiguous manner in the closed state by a locking system.

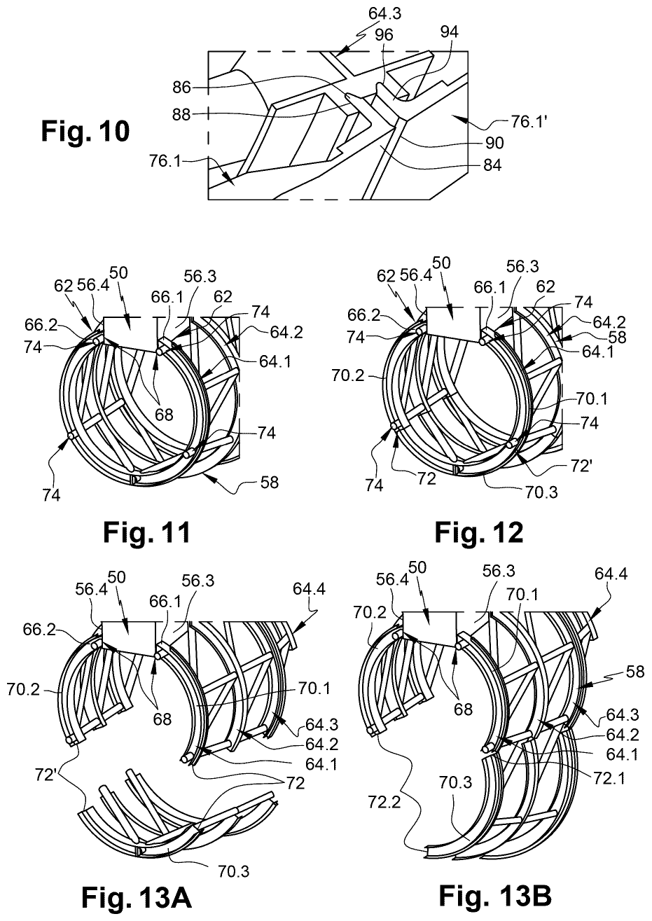

According to a configuration which can be seen in FIGS. 9 and 10, each of the first and second front cowlings 76.1, 76.2 comprises a front edge 82 configured to cooperate with the first transverse reinforcement 64.1 when the cowling is in the closed state and a rear edge 84 configured to cooperate with the third transverse reinforcement 64.3 when the cowling is in the closed state. The front edge 82 has a flange which cooperates with a groove provided in the region of the first transverse reinforcement 64.1. The rear edge 84 has a flange 86 which cooperates with a groove 88 provided in the region of the third transverse reinforcement 64.3. Each of the first and second rear cowlings 76.1′, 76.2′ comprises a front edge 90 configured to cooperate with the third transverse reinforcement 64.3 when the cowling is in the closed state and a rear edge 92. As illustrated in detail in FIG. 10, the front edge 90 has a flange 94 which cooperates with a groove 96 provided in the region of the third transverse reinforcement 64.3.

Each of the first and second front or rear cowlings 76.1, 76.1′, 76.2, 76.2′ is configured to be placed against the load-bearing structure 58 in the closed state.

The engine mount system 54 comprises at least one rear damping engine mount 98 configured to provide an absorption of the inertial loads of the rear part B of the engine unit 32. The rear damping engine mount 98 is positioned in a second transverse plane P2 offset to the rear relative to the first transverse plane P1, more particularly offset to the rear relative to the third transverse reinforcement 64.3.

This rear damping engine mount 98 is configured to provide an absorption of forces in the horizontal and vertical transverse directions Y, Z, as the inertial loads of the rear part B of the engine unit 32 and more particularly of the rear part 42.2 of the reactor core 42. According to one arrangement, the rear damping engine mount 98 is interposed between the rear part 42.2 of the reactor core 42 and at least one element from the nacelle 34 and the load-bearing structure 58. According to one arrangement, the rear damping engine mount 98 is interposed between the nacelle 34 and the rear part 42.2 of the reactor core 42. The rear damping engine mount 98 can extend over a part of the circumference or over the entire circumference of the engine unit 32.

According to one configuration, the rear damping engine mount 98 is integral with the nacelle and more particularly the first and second rear cowlings 76.1′, 76.2′ and/or the rear part B of the engine unit 32.

According to one embodiment which can be seen in FIG. 14, the rear damping engine mount 98 comprises a plurality of first studs 98.1 attached to the external surface of the rear part 42.2 of the reactor core 42 and distributed in a regular manner over at least one part of the circumference of the reactor core 42 in the same second transverse plane P2. Thus, the first studs 98.1 can be positioned over a part of the circumference or over the entire circumference of the reactor core 42.

In addition, the rear damping engine mount 98 comprises a plurality of second studs 98.2 attached to the internal surface F48 of the nacelle 34, more particularly first and second rear cowlings 76.1′, 76.2′, distributed in a regular manner over at least part of the circumference of the nacelle 34 and in a same second transverse plane P2. Thus the second studs 98.2 can be positioned over a part of the circumference or over the entire circumference of the nacelle 34.

The first and second studs 98.1, 98.2 are arranged so as to be placed against one another when the first and second rear cowlings 76.1′, 76.2′ are in the closed state. The first and/or second studs 98.1, 98.2 are made of an elastically deformable material, such as an elastomer, for example.

According to a configuration which can be seen in FIGS. 7 and 8, at least some second studs 98.2 are connected to one another by a ring 100 or at least a ring segment positioned in the second transverse plane P2.

As a variant, the rear damping engine mount 98 composes studs attached solely to the rear part B of the engine unit 32 or solely to the nacelle 34.

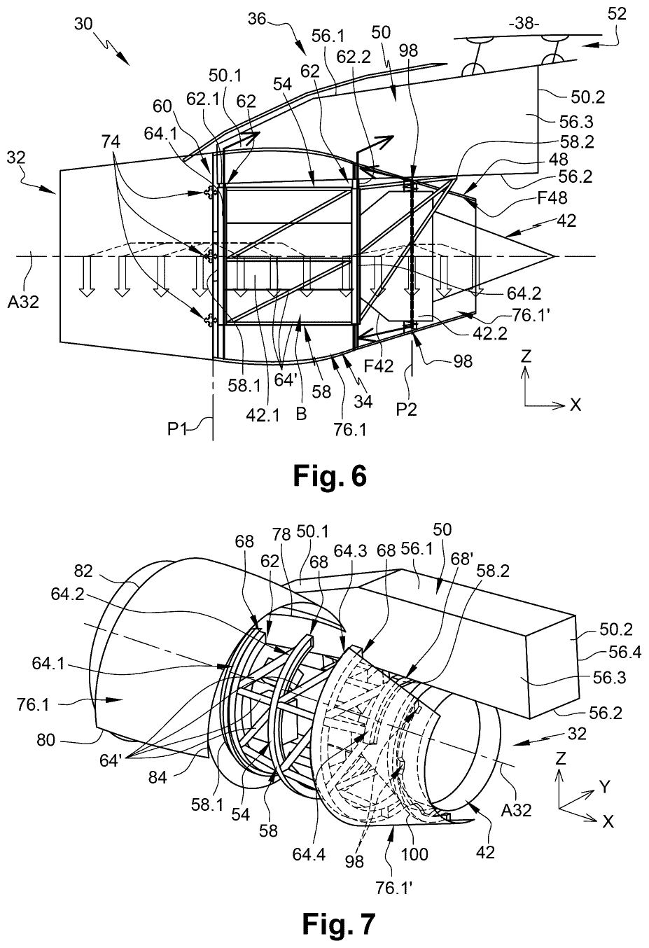

As illustrated in FIG. 6, the load-bearing structure 58 respectively connected to the front part A of the engine unit 32 and to the primary structure 50 of the pylon, and first and second connecting systems 60, 62 of the rigid type, form a force path between the engine unit 32 and the primary structure 50 of the pylon, this force path providing, among other things, the passage of thrust forces and aerodynamic forces from the fan and the absorption of the inertial loads of the front part A of the engine unit 32. In addition, the rear damping engine mount 98 provides an absorption of the forces of the inertial loads between the rear part B of the engine unit 32 and the load-bearing structure 58 and/or the nacelle 34 and does not participate in the passage of thrust forces and aerodynamic forces from the fan.

This configuration makes it possible to optimize the transmission of forces between the engine unit 32 and the primary structure 50 of the pylon.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. An aircraft propulsion assembly comprising:
an engine unit which comprises front and rear parts, the rear part being connected to the front part,
a primary structure of a pylon,
a nacelle configured to surround at least the rear part of the engine unit,
an engine mount system connecting the primary structure and the engine unit;
wherein the engine mount system comprises:
a load-bearing structure which extends between a front end and a rear end,
a first connecting system of a rigid type, positioned in a first transverse plane, connecting the front end of the load-bearing structure and the front part of the engine unit, and
a second connecting system of the rigid type connecting the load-bearing structure and the primary structure,
the load-bearing structure surrounding the rear part of the engine unit and being positioned between the engine unit and the nacelle,
wherein the engine mount system comprises at least one rear damping engine mount interposed between the rear part of the engine unit and at least one element from the nacelle and the load-bearing structure, the at least one rear damping engine mount being positioned in a second transverse plane offset to the rear relative to the first transverse plane, and
wherein the load-bearing structure comprises a plurality of sections configured to occupy an assembled state and a disassembled state, the sections of the load-bearing structure being configured so as to permit an insertion of the engine unit inside the load-bearing structure in the disassembled state.

2. The propulsion assembly according to claim 1, wherein the load-bearing structure is a trellis structure.

3. The propulsion assembly according to claim 2, wherein the load-bearing structure comprises at least two transverse reinforcements positioned in transverse planes and joint reinforcements connecting the transverse reinforcements so as to form the trellis structure, each transverse reinforcement describing a circular arc positioned in a transverse plane, and extending between first and second ends, each first and second end being connected to the primary structure, the second connecting system comprising, for each end thereof, a rigid connection connecting the second connecting system end and the primary structure.

4. The propulsion assembly according to claim 3, wherein at least one of the at least two transverse reinforcements comprises a first section connected to the primary structure, a second section connected to the primary structure and a lower section connected to the first and second sections by at least one of at least one dismountable connection or at least one hinge.

5. The propulsion assembly according claim 4, wherein the first connecting system comprises two front mounts positioned at each end of the first section of a first transverse reinforcement located furthest to the front and two front mounts positioned at each end of the second section of the first transverse reinforcement.

6. The propulsion assembly according to claim 1, wherein the propulsion assembly comprises at least one item of ancillary equipment supported by the load-bearing structure and connected thereto.

7. The propulsion assembly according to claim 1, wherein the rear damping engine mount comprises a plurality of first studs attached to an external surface of the rear part of the engine unit and positioned in the second transverse plane.

8. The propulsion assembly according to claim 1, wherein the rear damping engine mount comprises a plurality of second studs attached to an internal surface of the nacelle and positioned in the second transverse plane.

9. The propulsion assembly according to claim 7, wherein the rear damping engine mount comprises a plurality of second studs attached to an internal surface of the nacelle and positioned in the second transverse plane.

10. The propulsion assembly according to claim 9, wherein the first and second studs are arranged so as to be placed against one another.

11. The propulsion assembly according to claim 9, wherein at least some second studs are connected to one another by a ring or at least one ring segment positioned in the second transverse plane.

12. The propulsion assembly according to claim 9, wherein the nacelle comprises first and second cowlings, each configured to occupy a closed state in which the cowling is in a vicinity of the load-bearing structure and an open state in which the cowling is spaced apart from the load-bearing structure, and in that the second studs are attached to an internal surface of the first and second cowlings.

13. The propulsion assembly according to claim 9, wherein the first and second studs are made of a resiliently deformable material.

14. An aircraft comprising at least one propulsion assembly according to claim 1.
